(19) United States
(12) Patent Application Publication
(10) Pub. No.: US 2016/0219473 A1
(43) Pub. Date: Jul. 28, 2016

(54) Radio Access Node, Wireless Device and Methods for Handling Mobility Of The Wireless Device in a Radio Communication Network

(71) Applicant: TELEFONAKTIEBOLAGET L M ERICSSON (PUBL), Stockholm (SE)

(72) Inventors: Oumer TEYEB, SOLNA (SE); Angelo CENTONZA, STOCKHOLM (SE); Icaro L. J. DA SILVA, BROMMA (SE); Filip MESTANOV, SOLLENTUNA (SE)

(21) Appl. No.: 14/913,201

(22) PCT Filed: Aug. 22, 2014
(86) PCT No.: PCT/SE2014/050959

§ 371 Date: Feb. 19, 2016

Related U.S. Application Data
(60) Provisional application No. 61/869,099, filed on Aug. 23, 2013.

(51) Int. Cl. H04W 36/00; H04W 36/30; H04W 36/22

(52) U.S. Cl. CPC H04W 36/0094; H04W 36/22; H04W 36/30; H04W 36/0088

(57) ABSTRACT

Embodiments herein relate to a method performed in a first radio access node (12) for handling mobility of a wireless device (10) in a radio communications network (1), which radio communications network (1) comprises the first radio access node (12) controlling a first cell (11) and a second radio access node (13) controlling a second cell (15). The first radio access node (12) configures the wireless device (10) with one or more conditions to trigger a measurement report of received signals, which one or more conditions are at least partly related to the second cell (15) controlled by the second radio access node (13), and also to a third cell (16) associated with the second cell (15).

### TECHNICAL FIELD

Embodiments herein relate to a first radio access node, a second radio access node, a wireless device and methods performed therein. In particular for handling mobility of the wireless device in a radio communications network.

### BACKGROUND

In a typical radio communications network, wireless devices, also known as wireless terminals, mobile stations and/or user equipments (UEs), communicate via a Radio Access Network (RAN) to one or more core networks. The radio access network covers a geographical area which is divided into cell areas, with each cell area being served by a radio access node such as a base station, e.g., a radio base station (RBS), which in some networks may also be called, for example, a “NodeB” or “eNodeB”. A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole radio communications network is also broadcasted in the cell. One base station may have one or more cells. The base stations communicate over the air interface operating on radio frequencies with the wireless devices within range of the base stations in Uplink (UL) or Downlink (DL) transmissions.

A Universal Mobile Telecommunications System (UMTS) is a third generation mobile communication system, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for wireless devices. In a forum known as the Third Generation Partnership Project (3GPP), telecommunications suppliers propose and agree upon standards for third generation networks and UTRAN specifically, and investigate enhanced data rate and radio capacity. In some versions of the RAN as e.g. in UMTS, several base stations may be connected, e.g., by landlines or microwave, to a controller node, such as a radio network controller (RNC) or a base station controller (BSC), which supervises and coordinates various activities of the plural base stations connected thereto. The RNCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio base stations are directly connected to the EPC core network rather than to RNCs. In general, in E-UTRAN/LTE the functions of a RNC are distributed between the radio base stations, e.g. eNodeBs in LTE, and the core network. As such, the RAN of an EPS has an essentially “flat” architecture comprising radio base stations without reporting to RNCs.

### Wireless Device Measurements

Wireless devices can be configured to report measurements, mainly for the sake of supporting mobility. As specified in 3GPP TS 36.331 version 11.4.0 section 5.5.1, the E-UTRAN provides the measurement configuration applicable for a wireless device in RRC_CONNECTED mode by means of dedicated signalling, i.e. using the RRCConnectionReconfiguration message. RRC stands for Radio Resource Control. The following measurement configurations may be signalled to the wireless device:
Measurement objects: These define on what the wireless device should perform the measurements—such as a carrier frequency. The measurement object may also include a list of cells to be considered, white-list or black-list, as well as associated parameters, e.g. frequency- or cell-specific offsets.
Reporting configurations: These comprise the periodic or event-triggered criteria which cause the wireless device to send a measurement report, as well as the details of what information the wireless device is expected to report, e.g. the quantities, such as Received Signal Code Power (RSCP) for UMTS or Reference Signal Received Power (RSRP) for LTE, and the number of cells.
Measurement identities: These identify a measurement and define the applicable measurement object and reporting configuration. Each measurement identity links one measurement object with one reporting configuration. By configuring multiple measurement identities it is possible to link more than one measurement object to the same reporting configuration, as well as to link more than one reporting configuration to the same measurement object. The measurement identity is used as a reference number in the measurement report.
Quantity configurations: The quantity configuration defines the filtering to be used on each measurement. One quantity configuration is configured per Radio Access Technology (RAT) type, and one filter can be configured per measurement quantity.
Measurement gaps: Measurement gaps define time periods when no uplink or downlink transmissions will be scheduled, so that the wireless device may perform the measurements, e.g. inter-frequency measurements where the wireless device has only one Tx/Rx unit and supports only one frequency at a time. The measurement gaps are common for all gap-assisted measurements

The E-UTRAN configures only a single measurement object for a given frequency, but more than one measurement identity may use the same measurement object. The identifiers used for the measurement object and reporting configuration are unique across all measurement types. It is possible to configure the quantity which triggers the report, RSCP or RSRP, for each reporting configuration.

In LTE, the most important measurements metric used are the Reference Signal Received Power (RSRP) and Reference Signal Received Quality (RSRQ). RSRP is a cell specific measure of signal strength and it is mainly used for ranking different cells for handover and cell reselection purposes, and it is calculated as the linear average of the power of the Resource Elements (REs) which carry cell-specific Reference Signals (RSs). The RSRQ, on the other hand, also takes the interference into consideration by taking the total received wideband power into account as well.

One of the measurement configuration parameters that wireless devices receive from their serving eNBs is the S-measure, which tells the wireless device when to start measuring neighbouring cells. If the measured RSRP of the serving cell falls below the S-measure, indicating the signal of the serving cell is not that strong anymore, the wireless device starts measuring the signal strength of RSs from the neighbouring cells. The S-measure is an optional parameter and different S-measure values can be specified for initiating intra-frequency, inter-frequency and inter-RAT measurements.

Once the wireless device is enabled for measuring, the wireless device may report any of the following
The serving cell
Listed cells (i.e. cells indicated as part of the measurement object);
Detected cells on a listed frequency (i.e. cells which are not listed cells but are detected by the UE).

There are several measurement configuration parameters that specify the triggering of measurement reports from the wireless device. The following event-triggered criteria are specified for intra-RAT, within the same RAT, measurement reporting in LTE:
Event A1: Primary serving cell (PCell) becomes better than an absolute threshold.
Event A2: PCell becomes worse than an absolute threshold.
Event A3: Neighbour cell becomes better than an offset relative to the PCell.
Event A4: Neighbour cell becomes better than an absolute threshold.
Event A5: PCell becomes worse than one absolute threshold and neighbour cell becomes better than another absolute threshold.
Event A6: Neighbour cell becomes better than an offset relative to a secondary cell (SCell)

For inter-RAT, mobility between different RATs, the following event-triggered reporting criteria are specified:
Event B1: Neighbour cell becomes better than an absolute threshold.
Event B2: Serving cell becomes worse than one absolute threshold and neighbour cell becomes better than another absolute threshold.

The most widely used measurement report triggering event related to handover is A3, and its usage is illustrated in FIG. 1. The triggering conditions for event A3 can be formulated as:

N>S+HOM (condition 1)

where N and S are the signal strengths of the neighbour cell N and serving cell S, respectively, and HOM is the handover margin. HOM is the difference between the radio quality of the serving cell and the radio quality needed before attempting a handover. The radio quality may be measured either using RSRP or RSRQ.

The wireless device triggers the intra-frequency handover procedure by sending event A3 report to the eNB. This event occurs when the wireless device measures that the target cell is better than the serving cell with a margin “HOM”. The wireless device is configured over RRC when entering a cell and the HOM is calculated from the following configurable parameters:

HOM=Ofp+Ocp+Off−Ofn−Ocn+Hys
Where:
Ofp is a frequency specific offset of a primary frequency, i.e. offsetFreq as defined within measObjectEUTRA corresponding to the primary frequency.
Ofn is a frequency specific offset of a frequency of the neighbour cell, i.e. offsetFreq as defined within measObjectEUTRA corresponding to the frequency of the neighbour cell.
Ocp is a cell specific offset of the PCell, i.e. celllndividualOffset (C/O) as defined within measObjectEUTRA corresponding to the primary frequency, and is set to zero if not configured for the PCell.
Ocn is a cell specific offset of the neighbour cell, i.e. celllndividualOffset as defined within measObjectEUTRA corresponding to the frequency of the neighbour cell, and set to zero if not configured for the neighbour cell.
Hys is a hysteresis parameter for this event, i.e. hysteresis as defined within reportConfigEUTRA for this event.
Off is an offset parameter for this event, i.e. a3-Offset as defined within reportConfigEUTRA for this event.
Ofn, Ocn, Ofp, Ocp, Hys, Off are expressed in dB.

If the condition in (condition 1) is satisfied and it remains valid for a certain duration or time interval, known as Time To Trigger (TTT), the wireless device sends a measurement report to the serving eNB, e.g. in Figure, event A3 is satisfied at point A and measurement report is sent at point B in time, which means that signal N is larger than signal S+HOM over a period defined by the TTT. When the serving eNB gets the measurement report, it can initiate a handover towards the neighbour.

In addition to event-triggered reporting, the wireless device may be configured to perform periodic measurement reporting. In this case, the same parameters may be configured as for event-triggered reporting, except that the wireless device starts reporting periodically rather than only after the occurrence of an event.

Note that the handover measurement configuration parameters are set individually to each wireless device via dedicated RRC messaging, i.e. handover measurement configuration parameters may be unique for each wireless device. Also, different configuration parameters may be set for different neighbour cells.

### Handover in LTE

Handover is one of the important aspects of any radio communications network or mobile communication system, where the mobile communication system tries to assure service continuity of the wireless device by transferring the connection from one cell to another depending on several factors such as signal strength, load conditions, service requirements, etc. The provision of efficient/effective handovers, minimum number of unnecessary handovers, minimum number of handover failures, minimum handover delay, etc., would affect not only the Quality of Service (QoS) of the end user but also the overall radio communications network capacity and performance.

In LTE, wireless device-assisted, network controlled handover is utilized see 3GPP TS 36.300 version 11.6.0 section 10.1.2.1. A network node e.g. a radio access node such as an eNB configures the wireless device to send measurement reports and based on these measurement reports the wireless device is moved, if required and possible, to the most appropriate cell that will assure service continuity and quality. A wireless device measurement report configuration comprises reporting criterion or criteria, whether they are periodic or event triggered, as well as measurement information that the wireless device has to report.

Handover is performed via an X2 connection, whenever available, and if not, using S1, i.e. involving the Core Network (CN). An X2 Handover process is shown in FIGS. 2a-2b. The X2 handover process or procedure may be sub divided into three stages of preparation (initiation), execution and completion.

Below is a more detailed description of the intra-Mobility Management Entity (MME)/Serving Gateway HO procedure:

0 The wireless device context within the source eNB contains information regarding roaming restrictions which were provided either at connection establishment or at the last Timing Advance (TA) update. Hence, Area restriction information is provided within the network.

Step 1 The source eNB configures the wireless device measurement procedures according to the area restriction information. The Source eNB transmit measurement control information to the wireless device using layer 3 (L3) signalling. Measurements provided by the source eNB may assist the function controlling the UE's connection mobility.

Packet data may be exchanges between the wireless device and network, and within the network. The source eNB transmits UL allocation to the wireless device.

Step 2 A MEASUREMENT REPORT or reports are triggered and sent to the source eNB using L3 signalling.

Step 3 The source eNB makes a HO decision based on MEASUREMENT REPORT and Radio Resource Management (RRM) information to hand off the wireless device.

Step 4 The source eNB issues, using L3 signalling, a HANDOVER REQUEST message to a target eNB passing necessary information to prepare the HO at the target side. Wireless device X2/wireless device S1 signalling references enable the target eNB to address the source eNB and the EPC.

Step 5 Admission Control may be performed by the target eNB dependent on the received EPS Radio Access Bearer (E-RAB) QoS information to increase the likelihood of a successful HO, if the resources can be granted by target eNB. The target eNB configures the required resources according to the received E-RAB QoS information and reserves a Cell Radio Network Temporary Identifier (C-RNTI) and optionally a Random Access channel (RACH) preamble. The configuration to be used in the target cell can either be specified independently, i.e. an “establishment”, or as a delta compared to the configuration used in the source cell, i.e. a “reconfiguration”.

Step 6 The target eNB prepares HO with L1/L2 and sends the HANDOVER REQUEST ACKNOWLEDGE to the source eNB. The HAN DOVER REQUEST ACKNOWLEDGE message includes a transparent container to be sent to the wireless device as an RRC message to perform the handover. The container includes a new C-RNTI, target eNB security algorithm identifiers for the selected security algorithms, may include a dedicated RACH preamble, and possibly some other parameters i.e. access parameters, System Information Blocks (SIB), etc.

NOTE: As soon as the source eNB receives the HANDOVER REQUEST ACKNOWLEDGE, or as soon as the transmission of the handover command is initiated in the downlink, data forwarding may be initiated. The source eNB may transmit the DL allocation to the wireless device.

Steps 7 to 16 provide means to avoid data loss during HO.

Step 7 The target eNB generates the RRC message to perform the handover, i.e RRCConnectionReconfiguration message including the mobilityControlInformation, to be sent by the source eNB towards the wireless device. The source eNB performs the necessary integrity protection and ciphering of the message. The wireless device receives the RRCConnectionReconfiguration message with necessary parameters, i.e. new C-RNTI, target eNB security algorithm identifiers, and optionally dedicated RACH preamble, target eNB SIBs, etc., and is commanded by the source eNB to perform the HO. The wireless device does not need to delay the handover execution for delivering the Hybrid automatic repeat request (HARQ)/automatic repeat request (ARQ) responses to source eNB. The wireless device detach from old cell and synchronize to new cell. The source eNB deliver buffered and in transit packets to target eNB.

Step 8 The source eNB sends the Sequence Number (SN) STATUS TRANSFER message to the target eNB to convey the uplink Packet Data Convergence Protocol (PDCP) SN receiver status and the downlink PDCP SN transmitter status of E-RABs for which PDCP status preservation applies. The uplink PDCP SN receiver status includes at least the PDCP SN of the first missing UL Service Data Unit (SDU) and may include a bit map of the receive status of the out of sequence UL SDUs that the wireless device needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the wireless device shall be treated with PDCP status preservation.

The source eNB forward data to the target eNB, and the target eNB buffers packets from the source eNB.

Step 9 After receiving the RRCConnectionReconfiguration message including the mobilityControlInformation, wireless device performs synchronisation to target eNB and accesses the target cell via RACH, using L1/L2 signalling, following a contention-free procedure if a dedicated RACH preamble was indicated in the mobilityControlInformation, or following a contention-based procedure if no dedicated preamble was indicated. Wireless device derives target eNB specific keys and configures the selected security algorithms to be used in the target cell.

Step 10 The target eNB responds with UL allocation and timing advance for the wireless device, using L1/L2 signalling.

Step 11 When the wireless device has successfully accessed the target cell, the wireless device sends the RRCConnectionReconfigurationComplete message (C-RNTI), L3 signalling, to confirm the handover, along with an uplink Buffer Status Report, whenever possible, to the target eNB to indicate that the handover procedure is completed for the wireless device. The target eNB verifies the C-RNTI sent in the RRCConnectionReconfigurationComplete message. The target eNB can now begin sending data to the wireless device as indicated by the user data transfer.

Step 12 The target eNB sends, using L3 signalling, a PATH SWITCH REQUEST message to MME to inform that the wireless device has changed cell.

Step 13 The MME sends a MODIFY BEARER REQUEST message to the Serving Gateway using L3 signalling.

Step 14 The Serving Gateway switches the downlink data path to the target side. The Serving gateway sends one or more “end marker” packets on the old path to the source eNB and then can release any user plane resources towards the source eNB.

Step 15 The Serving Gateway sends a MODIFY BEARER RESPONSE message to the MME using L3 signalling.

Step 16 The MME confirms the PATH SWITCH REQUEST message with the PATH SWITCH REQUEST ACKNOWLEDGE message using L3 signalling.

Step 17 By sending the wireless device CONTEXT RELEASE message, the target eNB informs success of HO to source eNB using L3 signalling and triggers the release of resources by the source eNB. The target eNB sends this message after the PATH SWITCH REQUEST ACKNOWLEDGE message is received from the MME.

Step 18 Upon reception of the wireless device CONTEXT RELEASE message, the source eNB can release radio and cell plane related resources associated to the wireless device context. Any ongoing data forwarding may continue.

When an X2 handover is used involving Home eNBs (HeNB) and when the source HeNB is connected to a HeNB Gateway (GW), a wireless device CONTEXT RELEASE REQUEST message including an explicit GW Context Release Indication is sent by the source HeNB, in order to indicate that the HeNB GW may release all the resources related to the wireless device context.

Thus, based on the measurement results the source eNB is getting from the wireless device, the source eNB decides whether to handover the connection to another eNB or not (steps 1 to 3). Then handover preparation stage (steps 4 to 6) is entered and the decision to handover is communicated to the target eNB, and if the target eNB is able to admit the wireless device, a message is sent to the wireless device to initiate the handover e.g. RRC conn. Reconf. Including mobilitycontrolinfo. During the handover execution stage (steps 7 to 11), DL data arriving at the source eNB for the wireless device are forwarded to the target eNB. The wireless device synchronizes with the target eNB and send towards it the handover confirmation message, e.g. RRC Conn. Reconf. Complete, signifying that from the wireless device's point of view the handover is complete. During a handover completion phase (steps 12 and thereafter), a proper setup of the connection with the target eNB is performed, which include the switching of the DL path in the serving gateway, the old connection is released and any remaining data in the source eNB that is destined for the wireless device is forwarded to the target eNB. Then normal packet flow can ensue through the target eNB.

### Heterogeneous Networks

There have been several proposals to meet the ever increasing traffic demands and high quality expectations from end users for mobile broadband services. The upgrading of the existing base stations to use higher data rate technologies such as High Speed Packet Access (HSPA) or Long Term Evolution (LTE), or use other optimizations such as Multiple Input Multiple Output (MIMO), antenna tilting, etc is one of the most widely adopted means to meet these demands. This can be further enhanced by increasing the number of base stations, e.g. eNBs, in the network, known as macro densification. However, these methods of improving the data rate can provide system gains only to a certain extent and they can end up being very expensive. As such, the concept of Heterogeneous Networks, where the existing homogeneous network is overlaid with additional lower-power, low-complexity base stations, is currently being researched as a solution to mitigate the cost and/or capacity limitations of macro densification or upgrading. FIG. 3 illustrates a HetNet deployment scenario.

The homogeneous layer of macro cells is known as a “macro” layer, as the eNBs, or macros, in this layer have large coverage areas. The non-homogenous layer contains radio access nodes of lower power than the macros e.g. low power nodes such as “picos”, low power eNBs, for indoor or outdoor usage, “femtos”, home base stations (HeNBs) usually for indoor home usage, Wireless Local Area Network (WLAN) Access Points (AP), etc. Heterogeneous networks are expected to offer a low cost alternative to macro densification and will more likely be effective as the deployment of the low power nodes may be made more focused towards the hot spots and areas with coverage problems. The term “small cell” is sometimes used to refer to a pico, a femto or a WLAN cell in this document. In current HO procedures sometimes a handover is performed between target and source cells that reduces the performance of the communication due to the structure of the radio communications network e.g. a heterogeneous network.

### SUMMARY

An object of embodiments herein is to provide a mechanism that enables a handover in a radio communications network in an efficient manner.

According to an aspect the object is achieved by a method performed in a first radio access node for handling mobility of a wireless device in a radio communications network. The radio communications network comprises the first radio access node controlling a first cell and a second radio access node controlling a second cell. The first radio access node configures the wireless device with one or more conditions to trigger a measurement report of received signals, which one or more conditions is at least partly related to the second cell controlled by the second radio access node, and also to a third cell associated with the second cell.

According to another aspect the object is achieved by a method performed in a wireless device for handling signal measurements to a first radio access node in a radio communications network. The radio communications network comprises the first radio access node controlling a first cell and a second radio access node controlling a second cell. The wireless device configures settings, from the first radio access node, to trigger a reporting of a signal measurement when one or more conditions are fulfilled. The one or more conditions are at least partly related to the second cell controlled by the second radio access node, and also to a third cell associated with the second cell.

According to yet another aspect the object is achieved by a method performed in a second radio access node for a supporting mobility of wireless device in a radio communications network. The radio communications network comprises the second radio access node controlling a second cell and a first radio access node controlling a first cell. The second radio access node determines that the second cell is associated with a third cell.

According to still another aspect the object is achieved by a first radio access node for handling mobility of a wireless device in a radio communications network. The radio communications network comprises the first radio access node controlling a first cell and a second radio access node controlling a second cell. The first radio access node is configured to configure the wireless device with one or more conditions to trigger a measurement report of received signals, which one or more conditions is at least partly related to the second cell controlled by the second radio access node, and also to a third cell associated with the second cell.

According to yet still another aspect the object is achieved by a wireless device for handling signal measurements to a first radio access node in a radio communications network. The radio communications network comprises the first radio access node controlling a first cell and a second radio access node controlling a second cell. The wireless device is configured to configure settings, from the first radio access node, to trigger a reporting of a signal measurement when one or more conditions are fulfilled. The one or more conditions are at least partly related to the second cell controlled by the second radio access node, and also to a third cell associated with the second cell.

According to an additional aspect the object is achieved by a second radio access node for a supporting mobility of wireless device in a radio communications network. The radio communications network comprises the second radio access node controlling a second cell and a first radio access node controlling a first cell. The second radio access node is configured to determine that the second cell is associated with a third cell.

According to yet another aspect the object is achieved by a method performed in a radio communications network for handling mobility of a wireless device in the radio communications network. The radio communications network comprises the first radio access node controlling a first cell and a second radio access node controlling a second cell. The second radio access node determines that the second cell is associated with a third cell, and transmits an indication to the first radio access node. The indication indicates that the second cell is associated with the third cell. The first radio access node configures the wireless device with one or more conditions to trigger a measurement report of received signals. The one or more conditions are at least partly related to the second cell controlled by the second radio access node, and also to the third cell associated with the second cell.

An advantage of configuring the mobile device with one or more conditions that are at least partly related to the second cell controlled by the second radio access node, and also to the third cell associated with the second cell provide a mechanism that will make it possible, enables, to perform improved handovers between cells in e.g. heterogeneous networks by considering the condition/s of the second cell and any other cell associated with the second cell. This will lead to a more efficient handover process.

### BRIEF DESCRIPTION OF THE DRAWINGS

FIG. 1 discloses handover triggering in LTE.

FIG. 2 discloses signaling scheme of a Handover in LTE.

FIG. 3 discloses a heterogeneous network deployment.

FIG. 4 depicts an example scenario according to embodiments herein.

FIG. 5 is a schematic overview depicting a flowchart according to embodiments herein.

FIG. 6 is a schematic overview depicting a flowchart according to embodiments herein.

FIG. 7 is a schematic overview depicting a flowchart according to embodiments herein.

FIG. 8 is a schematic overview depicting a flowchart and signalling scheme according to embodiments herein.

FIG. 9 is a schematic overview depicting a flowchart and signalling scheme according to embodiments herein.

FIG. 10 is a schematic overview depicting a flowchart and signalling scheme according to embodiments herein.

FIG. 11 is a block diagram depicting a first radio access node according to embodiments herein.

FIG. 12 is a block diagram depicting a wireless device according to embodiments herein.

FIG. 13 is a block diagram depicting a second radio access node according to embodiments herein.

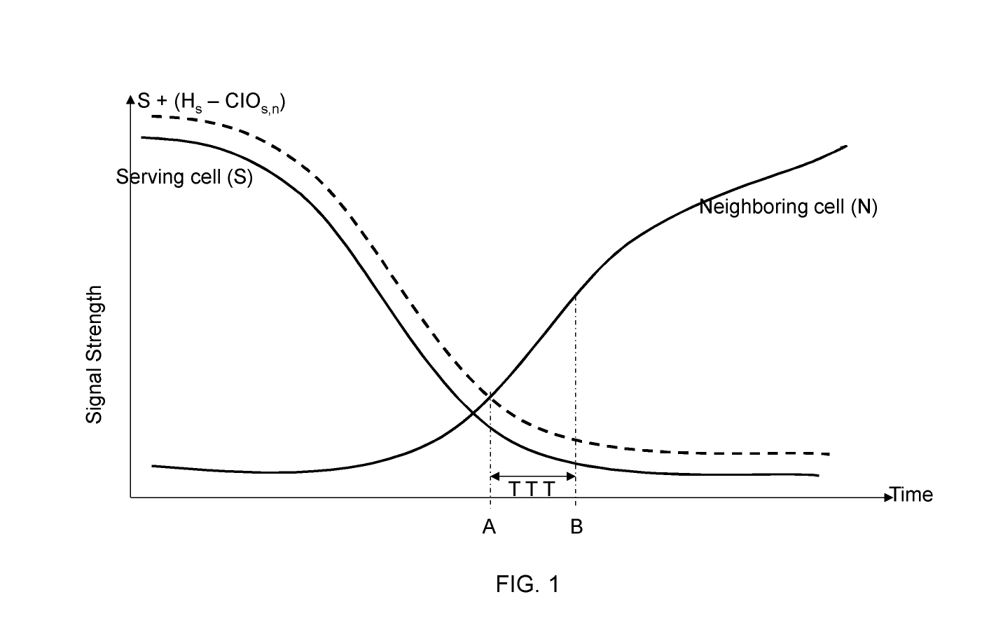

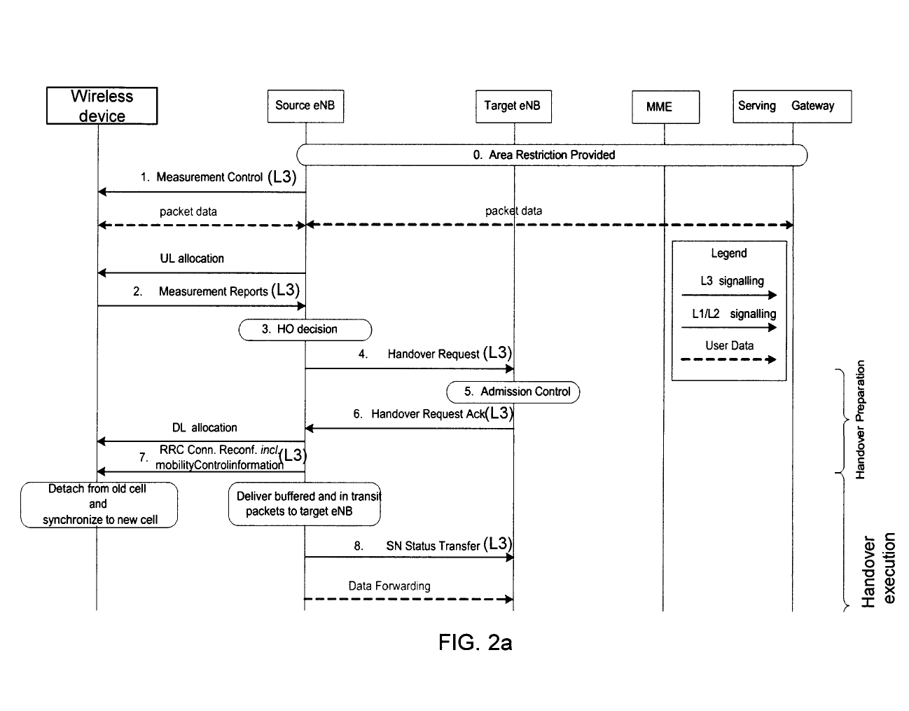

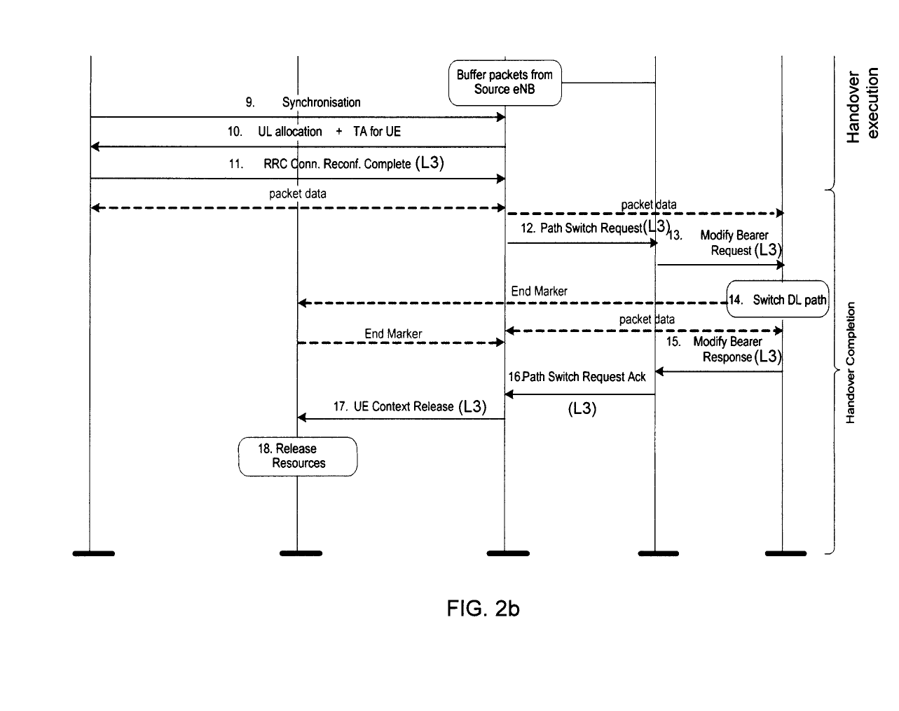

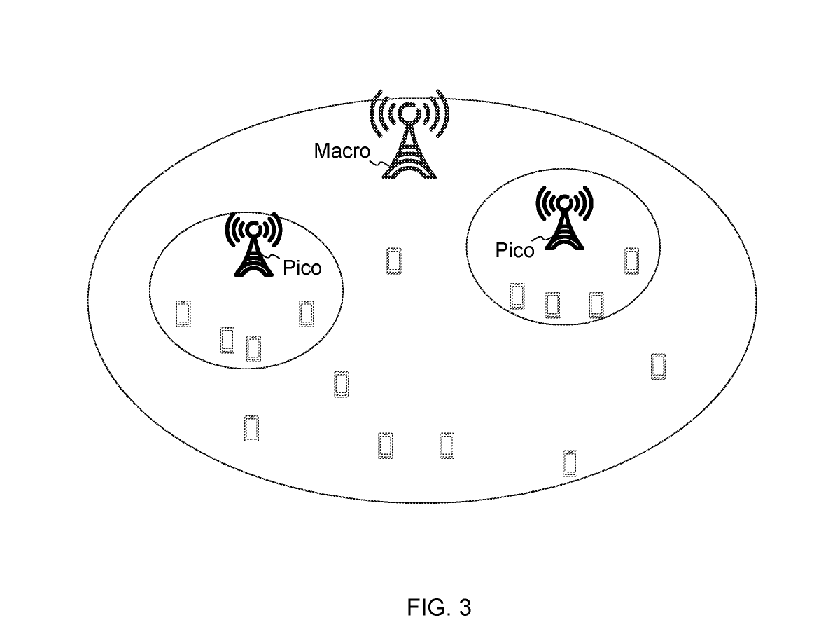

### DETAILED DESCRIPTION

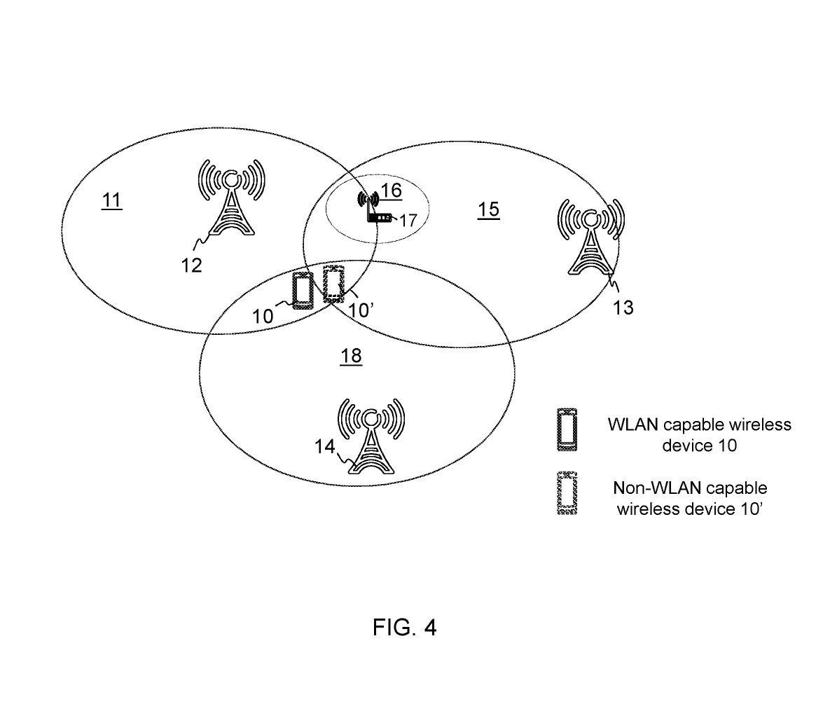

Embodiments herein relate to radio communications networks in general, may also be referred to as cellular networks or wireless communication network. FIG. 4 is a schematic overview depicting a radio communications network 1. The radio communications network 1 comprises one or more RANs and one or more CNs. The radio communications network 1 may use a number of different technologies, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), or any combination thereof just to mention a few possible implementations. The radio communications network 1 is exemplified herein as an LTE network.

In the radio communications network 1, a wireless device 10 and a second wireless device 10′, also known as mobile stations, user equipments and/or wireless terminals, communicate via a Radio Access Network (RAN) to one or more core networks (CN). It should be understood by the skilled in the art that “wireless device” is a non-limiting term which means any wireless terminal, user equipment, Machine Type Communication (MTC) device, a Device to Device (D2D) terminal, or node e.g. Personal Digital Assistant (PDA), laptop, mobile phone, sensor, relay, mobile tablets or even a small base station communicating within respective cell. The wireless device 10 is capable of accessing the radio communications network via different RATs. Furthermore, the second wireless device 10′ is not capable of accessing the radio communications network via different RATs.

The radio communications network 1 covers a geographical area which is divided into cell areas, e.g. a first cell 11 being served by a first radio access node 12. The first radio access node 12 may also be referred to as a first radio base station and e.g. a NodeB, an evolved Node B (eNB, eNode B), a base transceiver station, Access Point Base Station, base station router, or any other network unit capable of communicating with a wireless device within the cell served by the first radio access node 12 depending on e.g. the radio access technology and terminology used. The first radio access node 12 may serve one or more cells, e.g. the first cell 11 being exemplified herein as a macro cell.

A cell is a geographical area where radio coverage is provided by radio base station equipment at a base station site being an example of the first radio access node 12 or at remote locations in Remote Radio Units (RRU). The cell definition may also incorporate frequency bands and radio access technology used for transmissions, which means that two different cells may cover the same geographical area but using different frequency bands. Each cell is identified by an identity within the local radio area, which is broadcast in the respective cell. Another identity identifying the cell uniquely in the whole radio communications network 1 is also broadcasted in the cell. The first radio access node 12 communicates over the air or radio interface operating on radio frequencies with the wireless devices within range of the first radio access node 12. The wireless devices transmit data over the radio interface to the radio access node 12 in Uplink (UL) transmissions and the first radio access node 12 transmits data over an air or radio interface to the wireless devices in Downlink (DL) transmissions.

Furthermore, the radio communications network 1 may comprise a second radio access node 13, such as a target eNB, a neighboring base station to the first radio access node 12, a macro base station, or a femto base station, providing radio coverage over a second cell 15 e.g. a second macro cell. Furthermore a third cell 16 is comprised within the second cell 15 provided by a third radio access node 17, e.g. a cell being of a different radio access technology and/or size such as a WLAN cell. Herein the third cell is associated with the second cell 16 in that the third cell is covered at least partly by the second cell 15 and/or the second cell 15 being a master cell and the third cell 16 being a slave cell. The third cell 16 may offload the second cell 15 in terms of load from wireless devices.

Additionally, the radio communications network 1 may comprise a fourth radio access node 14, such as a target eNB, a neighboring base station to the first and/or second radio access node, a macro base station, or a femto base station, providing radio coverage over a fourth cell 18 e.g. a third macro cell. The wireless device 10 is moving or travelling within the first cell 11 and moves into one or more of the other cells 15-18.

As part of developing embodiments herein a problem will first be identified and discussed. As described in above, current handover procedures in LTE consider only measurement reports that compare the signal levels of source and target cells. Assuming A3 event trigger is applied, if the signal level of the target cell is above a certain threshold from the source cell for certain duration, measurement reports are triggered from the wireless device, and the source may then hand the wireless device over to the target cell.

Though this approach is very practical in case of homogenous networks, it has limitations in the case of e.g. heterogeneous networks as illustrated, especially when there are small cells supporting other technology such as WLAN. An example is given in FIG. 4, where the first radio access node 12 is serving two wireless devices, the first wireless device 10 with WLAN capability and the second wireless device 10′ without WLAN capability. Assume also that just based on the comparison of the source and target cells, the third radio access node 14 is the best candidate. However, it may be better to handover the wireless device 10 that support WLAN towards the second radio access node 13 instead, even though the signal level of the fourth cell 18 from the third radio access node 14 is better than signal level of the second cell 15 of the second radio access node 13, as there it is likely that the wireless device 10 might be offloaded to the WLAN Access Points (AP) soon after being handed over to the second radio access node 13 where the wireless device 10 then may get better conditions.

Some embodiments herein relate to a method performed in the radio communications network 1 for handling mobility of the wireless device 10 in the radio communications network 1. The second radio access node 13 determines that the second cell 15 is associated with the third cell 16. The second radio access node 13 transmits an indication to the first radio access node 12, which indication indicates that the second cell is associated with the third cell 16. The first radio access node 12 configures the wireless device 10 with one or more conditions to trigger a measurement report of received signals. The one or more conditions are at least partly related to the second cell controlled by the second radio access node 13, and also to the third cell 16 associated with the second cell 15.

Hence, embodiments herein enable handling mobility of the wireless device 10 wherein it is taken into account whether a cell is associated with other cells, such as a macro cell covering areas wherein small cells, such as WLAN cells, are also providing radio coverage. Some embodiments herein relate to determine such an association of e.g. the second cell 15 and the third cell 16 at e.g. the second radio access node 13. Furthermore, some embodiments relate to performing a handover wherein the first radio access node 12 takes into account that the second cell 15 is associated with the third cell 16. In addition, embodiments describe enhancements to e.g. HO triggering events, where not only the source and target macro cell conditions are compared, but also the conditions in a small cell e.g. the third cell 16, controlled by a macro cell, e.g. the second cell 15.

According to some embodiments herein the wireless device 10 triggers a measurement report based on data regarding the fourth radio access node 14 and second radio access node 13 but also that the second radio access node 13 comprises other cells of e.g. a different RAT such as a WLAN cell. The first radio access node 12 may further take wireless device capability into account when taking a HO decision. E.g. the first radio access node 12 may handover the non WLAN wireless device 10′ to the third radio access node 14 but the WLAN capable wireless device 10 is handed over to the second radio access node 13.

Embodiments herein provide a mechanism that enables performing improved handovers between cells in e.g. heterogeneous networks, wherein radio access nodes as well as wireless devices may have different capabilities, by considering the condition/s of the cells and any other small cells associated with the cells e.g. being at least partly within their coverage area, and thus being associated with one another.

### WLAN Integration

In IEEE, W-Fi, also known as WLAN and these terms will be used interchangeably throughout this document, is standardized in the 802.11 specifications “IEEE Standard for Information technology—Telecommunications and information exchange between systems. Local and metropolitan area networks—Specific requirements. Part 11: Wireless LAN Medium Access Control (MAC) and Physical Layer (PHY) Specifications”. Wi-Fi is a technology that currently mainly operates on the 2.4 GHz or the 5 GHz band. The IEEE 802.11 specifications regulate a station (STA) e.g. access points or wireless terminals, physical layer, MAC layer and other aspects to secure compatibility and inter-operability between access points and portable terminals, here from referred to as wireless devices. Wi-Fi is generally operated in unlicensed bands, and as such, communication over Wi-Fi may be subject to interference sources from any number of both known and unknown devices. Wi-Fi is commonly used as wireless extensions to fixed broadband access, e.g., in domestic environments and hotspots, like airports, train stations and restaurants.

Recently, Wi-Fi has been subject to increased interest from cellular network operators, not only as an extension to fixed broadband access. The interest is mainly about using the Wi-Fi technology as an extension, or alternative to cellular radio access network technologies to handle the always increasing wireless bandwidth demands. Cellular operators that are currently serving mobile users with, e.g., any of the 3GPP technologies, LTE, UMTS/WCDMA, or GSM, see Wi-Fi as a wireless technology that can provide good support in their regular radio communications networks. The term “operator-controlled W-Fi” points to a Wi-Fi deployment that on some level is integrated with a cellular network operators existing network and where the 3GPP radio access networks and the Wi-Fi wireless access may even be connected to the same core network and provide the same services.

There is currently quite intense activity in the area of operator-controlled Wi-Fi in several standardization organizations. In 3GPP, activities to connect Wi-Fi access points to the 3GPP-specified core network is pursued, and in Wi-Fi Alliance, WFA, activities related to certification of Wi-Fi products are undertaken, which to some extent also is driven from the need to make Wi-Fi a viable wireless technology for cellular operators to support high bandwidth offerings in their networks. The term Wi-Fi offload is commonly used and points towards that cellular network operators seek means to offload traffic from their cellular networks to W-Fi, e.g., in peak-traffic-hours and in situations when the cellular network for one reason or another needs to be off-loaded, e.g., to provide requested quality of service, maximize bandwidth or simply for coverage.

For a wireless operator, offering a mix of two technologies that are standardized in isolation from each other, comes the challenge of providing intelligent mechanisms that interact with both technologies, such as connection management.

Most current Wi-Fi deployments are totally separate from radio communications networks, and are to be seen as non-integrated. From the wireless device perspective, mobile operating systems may support a simple connection management mechanism, where the wireless devices immediately switch all their Packet Switched (PS) bearers to a Wi-Fi network upon a detection of such a network with a certain signal level. The decision to offload to a WI-Fi or not is referred henceforth as access selection strategy and the aforementioned strategy of selecting WI-Fi whenever such a network is detected is known as “Wi-Fi-if-coverage”. While this may be a good strategy, e.g., for WI-Fi deployed as extensions of a residential broadband connection to a fixed line operator, cellular network operators that aim to integrate Wi-Fi as a component in their wireless networks, more is desired.

A RAN controlled traffic steering is currently being discussed in 3GPP in relation to a study item called WLAN/3GPP Interworking, described in 3GPP TR 37.834 v. 0.3.0 Study on WLAN/3GPP Radio Interworking (Release 12) and in study item description RP-122038 in 3GPP. Therein it is stated that one of the objective with a new solution is that it should be able to take dynamically changing conditions like radio access network load and performance into account. One of the solution proposals discussed is a RAN controlled approach. With a RAN controlled access selection it is the network, and not the wireless device, that takes the decision on what access link to use for communication to or from a wireless device. The RAN control of traffic steering should be able to capture the dynamics in varying radio conditions as well as provide predictability to better be able to optimize radio access network performance as well as user performance.

For the rest of this document, the term “master” is used to refer to the macro cells and “slave” to the small cells, such as pico cells, WLAN APs, etc. . . . , that are in proximity or under the macro cell coverage in a way that the macro base station can decide to offload traffic to the small cells/to.

In some embodiments herein, small cells e.g. the third cell 16 such as pico cells and cells from WLAN APs, are associated with a master macro cell, e.g. the second cell 15, in a many-to-one fashion, i.e., one macro controlling several small cells and each small controlled by one macro. The second cell 15 and the third cell 16 is of a same or different radio access technology.

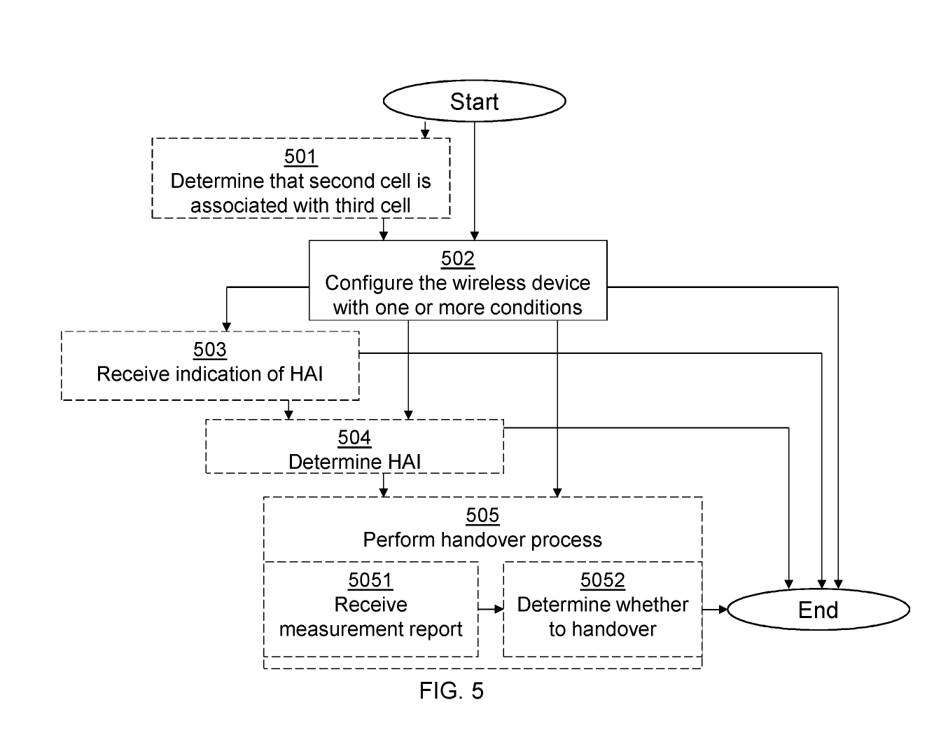

The method actions in a neighbouring radio access node to a radio access node having such an association, which neighbouring radio access node is referred to as the first radio access node 12 in herein, for handling mobility of the wireless device 10 in the radio communications network 1 according to some embodiments will now be described with reference to a flowchart depicted in FIG. 5. The radio communications network 1 comprises the first radio access node 12 controlling the first cell 11 and the second radio access node 13 controlling the second cell 15. The actions do not have to be taken in the order stated below, but may be taken in any suitable order. Actions performed in some embodiments are marked with dashed boxes.

Action 501. The first radio access node 12 may determine that the second cell 15 is associated with the third cell 16. The second cell may be associated with the third cell in that the second cell 15 is a master cell and the third cell 16 is a slave cell. E.g. the first radio access node 12 may receive an indication from the second radio access node 13 that the second cell 15 is associated with the third cell 16.

Action 502. The first radio access node 12 configures the wireless device 10 with one or more conditions to trigger a measurement report of received signals, which one or more conditions are at least partly related to the second cell 15 controlled by the second radio access node 13, and also to the third cell 16 associated with the second cell 15. For example, the first radio access node 12 may send configuration data to the wireless device 10 indicating the one or more conditions by indicating one or more rules for triggering reporting of received signal strengths. The one or more rules may comprise threshold values of the second cell 15 and/or the third cell 16, respectively. The threshold values may be absolute values or values relative values of the first radio access node 12 or other radio access nodes. Wireless devices, such as the wireless device 10, may be provided with measurement configurations, from the RAN such as the first radio access node 12, that combine the conditions from the second cell 15 and third cell 16, being neighbour cells. For example, a HO trigger event Ax may be defined that contains a set of conditions like:
{(RSRPm0), (RSRPs0/RSSIs0), (RSRPm1, RSRPs1/RSSIs1), (RSRPm2, RSRPs2/RSSIs2), (RSRPm3, RSRPs3/RSSIs3), . . . }

These represent e.g. a Report triggering—parameter set, where RSRPm0 defines Reference Signal Received Power from master 0 and RSSIs0 defines Received Signal Strength Indicator from slave 0 and so on. A parameter may be a RSRP divided by RSSI of the different nodes. The paired values correspond to RSRP of the second cell 15 and the third cell 16 have to be to trigger a measurement report from the wireless device 10. In the above example, the wireless device 10 will send a measurement report if it finds a neighbor macro cell that has an RSRP of RSRPm0 or higher; or if it finds a slave cell that has an RSRP/RSSI of RSRPs0/RSSIs0 or higher; or finds a macro cell that has an RSRP of RSRPm1 or higher and a slave cell belonging to it has an RSRP of RSRPs1 or higher; or has an RSRP of RSRPm2 or higher and a slave cell belonging to this cell has an RSRP of RSRPs1 or higher, etc.

Report triggering - pseudo code

if (RSRP_master >= RSRPm0)
OR if (RSRP_slave/RSSI_slave >= RSRPs0/RSSIs0)
OR if (RSRP_master >= RSRPm1) AND (RSRP_slave/RSSI_slave >=
RSRPs1/RSSIs1)
OR if (RSRP_master >= RSRPm2) AND (RSRP_slave/RSSI_slave >=
RSRPs2/RSSIs2)
[...]
THEN start REPORTING

The different pairs may be threshold values rather than absolute RSRP values to be compared with the current serving cells RSRP, as in the case of A3 event, and also different TTT values may be associated for each set of values. Note that as shown in the example above the thresholds or absolute values may be for cells using the same technology, for example the RSRP values for both macro and small cell using LTE, or different technology, for example macro using LTE and small cell using WLAN, where the macro values refer to RSRP values/thresholds, and the small cell values refer to RSSI values/thresholds.

A handover affiliated index (HAI) of the second radio access node 13 may be used in embodiments herein. The HAI indicates on how much or many the second cell 15 and the third cell 16 are able to accommodate load or wireless devices. The HAI may be based on load in the second cell 15 and/or load in the third cell 16. For example, an index value of 0 for a macro cell can mean the macro cell as well as the small cells under its coverage area are overloaded, while a value of 10 can mean the load is negligible and the macro and its slave cells can accommodate new wireless devices. One or more rules may be related to the HAI of the second radio access node 13, which HAI indicates on how much the second cell 15 and third cell 16 are able to accommodate wireless devices. E.g. the one or more rules may indicate a threshold value for each cell, wherein the threshold values are based on the HAI of the second cell and the third cell, respectively. The first radio access node 12 may thus send configuration data to the wireless device 10 indicating one or more rules for triggering reporting of received signal strengths. The one or more rules may comprise threshold values, e.g. load values and/or signal strength values, of the second and third cell. The values may be absolute values or values relative values of the radio access node or other radio access nodes. The rule may in other embodiments indicate a threshold value for each cell out of a number of cells, wherein the threshold value may be based on status of the cell out of a number of cells, such as the second cell 15, and it's associated cell, such as the third cell 16.

Action 503. The first radio access node 12 may receive from the second radio access node 13, an indication of the HAI of the second radio access node 13. The signaling may occur e.g. via X2 interface, for example as part of the LOAD INFORMATION procedures. The HAI information may be used by the first radio access node 12 to configure wireless device measurements or it may be used to influence the handover trigger point towards the second cell 15 associated with the signaling third cell 16 or towards the third cell 16 itself. An example of how this may be done is shown below. Depending on the HAI values that the first radio access node 12 is receiving from its macro neighbours such as the second radio access node 13, a first cell 11 or first radio access node 12 may adjust the RSRP thresholds required to trigger measurement report on a per neighbour basis, and this is communicated to the wireless device 10, where to each macro neighbour, identified via the Physical Cell ID (PCI), a different threshold is associated.

{(PCI_0, RSRPm0), (PCI_1, RSRPm1), (PCI_2, RSRPm2), . . . }

These represent Report triggering per specific neighbour—parameters, wherein the first radio access node 12 uses different threshold values e.g. RSRPs, for different cell identities based on reported HAI.

Report triggering per specific neighbor - pseudo code

if (PCI_master == PCI_0) AND (RSRP >= RSRPm0)
OR if (PCI_master == PCI_1) AND (RSRP >= RSRPm1)
OR if (PCI_master == PCI_2) AND (RSRP >= RSRPm2)
[...]
THEN start REPORTING

The value of HAI may be used as an additional parameter in the handover triggering events/conditions. For example, a HO measurement trigger event Ay may be defined in a way that contains a set of conditions like:

{(RSRPm0, HAI0), (RSRPm1, HAI1), (RSRPm2, HAI2), . . . }

These represent Report triggering with HAI—parameters, where the paired values correspond to the RSRP and the HAI values should be fulfilled to trigger measurement report from the wireless device 10. This will provide the possibility for the first radio access node 12 to handover the wireless device 10 to a cell, e.g. the second cell 15, with high handover affinity but with a relatively lower signal quality than to a cell, e.g. the fourth cell 18, with very low handover affinity but with a relatively better signal quality.

Report triggering with HAI - pseudo code

```
    if (RSRP_master >= RSRPm0) AND (HAI_master >= HAI0)
OR if (RSRP_master >= RSRPm1) AND (HAI_master >= HAI1)
OR if (RSRP_master >= RSRPm2) AND (HAI_master >= HAI2)
                                    [...]
THEN start REPORTING
```

As stated above, the macro cells, such as the second radio access node 13, may report neighbor-specific HAI values. For example, consider neighboring macro cells A, B and C, and that there are 10 small cells in B, and 9 of them are very close to the cell border of cell A while only 1 is close to the border of cell C. Thus that means that the affinity to receive wireless devices from cell A might be much higher than from cell C, so cell B can broadcast different HAI values along with to which neighbor cell they refer to (e.g., {HAI1, A}; {HAI2, B}; etc.). In this way wireless devices coming from cell A can use different HAI values than the wireless devices coming from cell B. Another possibility is to have a scaling factor communicated between neighbor macros and the cells configure their wireless devices report triggering parameters with this scaling factor. For the example above, cell B can tell A to scale up the affinity by a certain value, and cell C to scale down the affinity by a certain value, and cell A can configure the event Ay so that HAI values are lowered, and cell C can configure the event Ay so that HAI values are increased.

Please note that the triggering conditions in the embodiments above, HAI values as well as signal levels of both master and slave cells, may be combined.

Action 504. The first radio access node 12 may in some embodiments determine the HAI based on load in the second radio access node 13. E.g. indication of the load may be received from the second radio access node 13.

Action 505. The first radio access node 12 performs a handover process of the wireless device 10 from the first cell 11 taking into account that the second cell 15 is associated with the third cell 16. E.g. the first radio access node 12 may receive, action 5051, a measurement report of the second cell and/or third cell 16 from the wireless device 10 indicating fulfilled one or more conditions. The first radio access node 12 may then determine, action 5052, whether to handover the wireless device 10 to the second radio access node 13 based on the received measurement report and/or capability of the wireless device 10 e.g. capability to communicate over a plurality of radio access technologies, capability to communicate on a certain radio access technology, e.g. WLAN, capability to use a certain frequency, e.g. 2.5 GHz vs 5 GHz, capability of supporting Multiple Input Multiple Output (MIMO), etc.

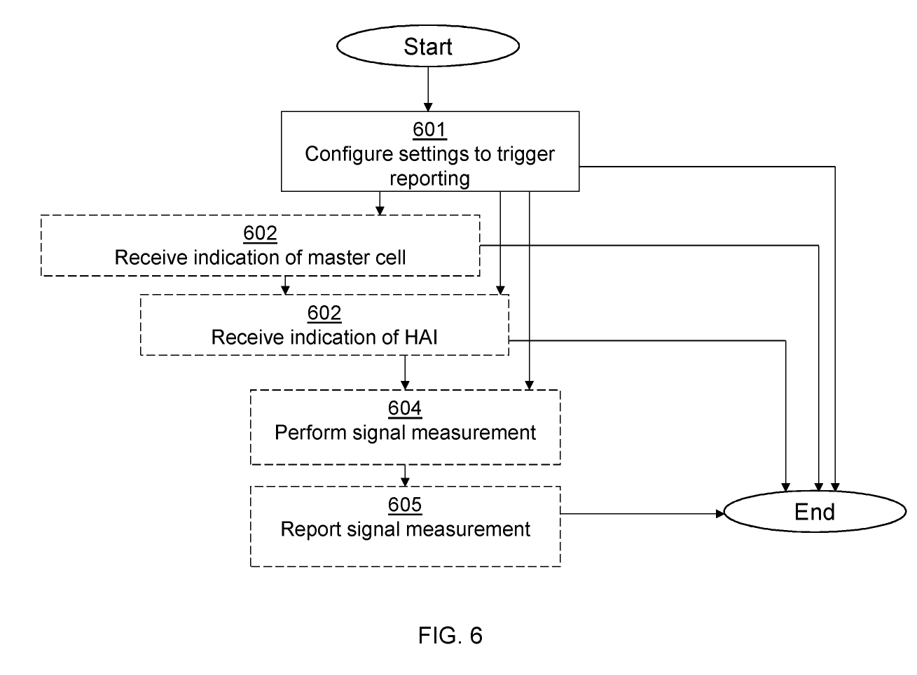

The method actions performed in the wireless device 10 for reporting signal measurements in the radio communications network 1 according to some embodiments will now be described with reference to a flowchart depicted in FIG. 6. The actions do not have to be taken in the order stated below, but may be taken in any suitable order. Actions performed in some embodiments are marked with dashed boxes. The radio communications network 1 comprises the first radio access node 12 controlling the first cell 11 and the second radio access node 13 controlling the second cell 15.

Action 601. The wireless device 10 configures settings, from the first radio access node 12 and/or the second radio access node 13, to trigger a reporting of a signal measurement when one or more conditions are fulfilled. The one or more conditions are at least partly related to or associated with the second cell 15 controlled by the second radio access node 13, and also to the third cell 16 associated with the second cell 15. E.g. the wireless device 10 may receive configuration data from the first radio access node 12 and/or the second radio access node 13 indicating the one or more conditions by indicating one or more rules for triggering reporting of received signal strengths. The one or more rules may comprise threshold values of the second cell 15 and third cell 16, respectively. And the threshold values may be absolute values or values relative values of the first radio access node 12 or other radio access nodes. The second cell 15 is associated with the third cell 16 in that the second cell 15 is a master cell and the third cell 16 is a slave cell.

Action 602. The wireless device 10 may receive an indication from the third radio access point 17 controlling the third cell 16, which indication indicates that the second cell is a master cell and wherein the one or more conditions are related the master cell and a slave cell. In some embodiments herein, small cells, such as pico cells and WLAN APs, broadcast information identifying the macro cell that controls them. Master cell, on the other hand, may not broadcast such information or broadcast their own identity as their master. With the help of this master information the wireless device 10, when performing their measurements, can associate the measurements from the master and slave cells.

Action 603. The wireless device 10 may receive the broadcasted indication of the HAI of the second radio access node 13, wherein the one or more conditions are related to the HAI. The value of the HAI may be used as an additional parameter in the handover triggering events/conditions. For example, a HO measurement trigger event Ay may be defined in a way that contains a set of conditions like:

{(RSRPm0, HAI0), (RSRPm1, HAI1), (RSRPm2, HAI2), . . . }

The wireless device 10 may then be configured from the first radio access node with paired values that correspond to the RSRPs, and the HAI values should be fulfilled to trigger measurement report from the wireless device 10. This will provide the possibility for the first radio access node 12 to handover the wireless device 10 to a cell, e.g. the second cell 15, with high handover affinity but with a relatively lower signal quality than to a cell, e.g. the fourth cell 18, with very low handover affinity but with a relatively better signal quality.

Report triggering with HAI - pseudo code

```
    if (RSRP_master >= RSRPm0) AND (HAI_master >= HAI0)
OR if (RSRP_master >= RSRPm1) AND (HAI_master >= HAI1)
OR if (RSRP_master >= RSRPm2) AND (HAI_master >= HAI2)
                                    [...]
THEN start REPORTING
```

Action 604. The wireless device 10 may perform a signal measurement on the second cell 15 and/or the third cell 16.

Action 605. When the one or more conditions are fulfilled, the wireless device 10 may report the signal measurement to the first radio access node 12.

In embodiments herein, the wireless device 10 may be provided with measurement configurations, from the RAN, such as the first and second radio access node, that combine the conditions from the master and slave neighbor cells. For example, a HO trigger event Ax can be defined that contains a set of conditions like:
{(RSRPm0), (RSRPs0/RSSIs0), (RSRPm1, RSRPs1/RSSIs1), (RSRPm2, RSRPs2/RSSIs2), (RSRPm3, RSRPs3/RSSIs3), . . . }

These represent Report triggering—parameter set, wherein RSRPm0 defines Reference Signal Received Power from master 0 and RSSIs0 defines Received Signal Strength Indicator from slave 0 and so on. A parameter may be a RSRP divided by RSSI of the different nodes. The paired values correspond to RSRP of the master and the slave neighbor cell have to be to trigger a measurement report from the wireless device 10. In the above example, the wireless device 10 will send a measurement report if it finds a neighbor macro cell that has an RSRP of RSRPm0 or higher; or if it finds a slave cell that has an RSRP/RSSI of RSRPs0/RSSIs0 or higher; or finds a macro cell that has an RSRP of RSRPm1 or higher and a slave cell belonging to it has an RSRP of RSRPs1 or higher; or has an RSRP of RSRPm2 or higher and a slave cell belonging to this cell has an RSRP of RSRPs1 or higher, etc.

Report triggering - pseudo code

```
    if (RSRP_master >= RSRPm0)
OR if (RSRP_slave/RSSI_slave >= RSRPs0/RSSIs0)
OR if (RSRP_master >= RSRPm1) AND (RSRP_slave/RSSI_slave >=
RSRPs1/RSSIs1)
OR if (RSRP_master >= RSRPm2) AND (RSRP_slave/RSSI_slave >=
RSRPs2/RSSIs2)
                                    [...]
THEN start REPORTING
```

The different pairs may be threshold values rather than absolute RSRP values to be compared with the current serving cells RSRP, as in the case of A3 event, and also different TTT values can be associated for each set of values. Note that as shown in the example above the thresholds or absolute values can be for cells using the same technology, for example the RSRP values for both macro and small cell using LTE, or different technology, for example macro using LTE and small cell using WLAN, where the macro values refer to RSRP values/thresholds, and the small cell values refer to RSSI values/thresholds.

The one or more conditions may also take HAI of neighbour radio access nodes into account, e.g. RSRP thresholds are adjusted required to trigger measurement report on a per neighbor basis, and this is communicated to the wireless device 10, where to each macro neighbour, such as the second radio access node 13—identified via the Physical Cell ID (PCI), a different threshold is associated.

{(PCI_0, RSRPm0), (PCI_1, RSRPm1), (PCI_2, RSRPm2), . . . }

These represent Report triggering per specific neighbor—parameters, wherein the first radio access node 12 uses different threshold values e.g. RSRPs, for different cell identities based on reported HAI.

Report triggering per specific neighbor - pseudo code

if (PCI_master == PCI_0) AND (RSRP >= RSRPm0)
OR if (PCI_master == PCI_1) AND (RSRP >= RSRPm1)
OR if (PCI_master == PCI_2) AND (RSRP >= RSRPm2)
[...]
THEN start REPORTING

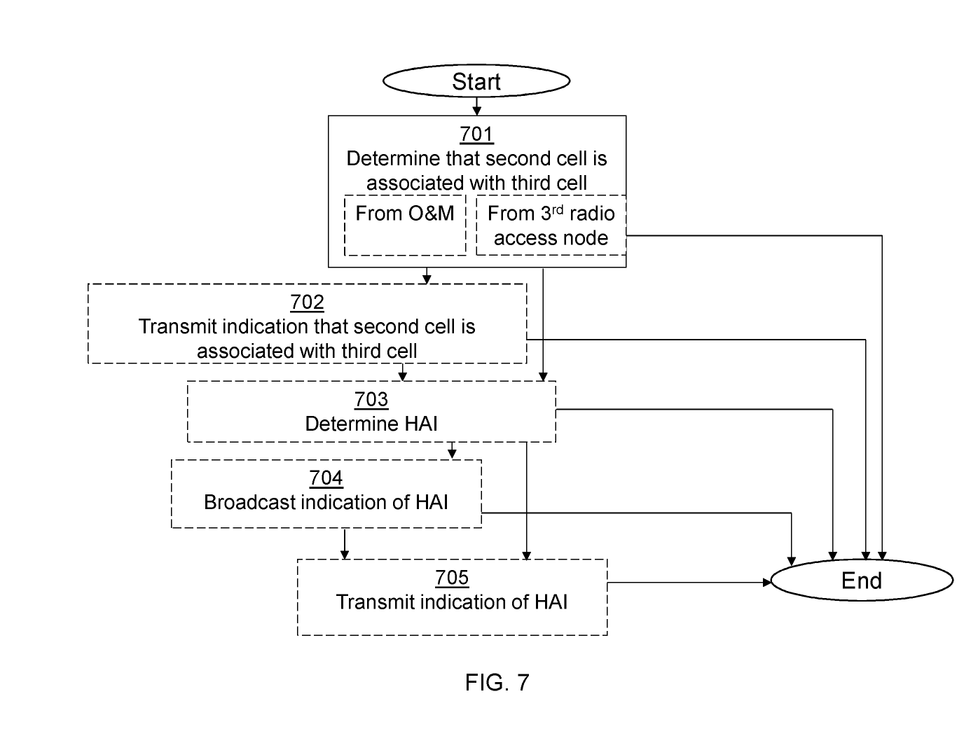

The method actions in a radio access node having such an association, referred to as second radio access node 13 in the figures, for supporting mobility of the wireless device 10 in the radio communications network 1 according to some embodiments will now be described with reference to a flowchart depicted in FIG. 7. The radio communications network 1 comprises the second radio access node 13 controlling the second cell 15 and the first radio access node 12 controlling the first cell 11. The actions do not have to be taken in the order stated below, but may be taken in any suitable order. Actions performed in some embodiments are marked with dashed boxes.

Action 701. The second radio access node 13 determines that the second cell 15 is associated with a third cell 16. This fact that the second cell 15 is associated with a third cell 16 may be taken into account when handling mobility of the wireless device 10 in the radio communications network 1 e.g. in the first radio access node 12. The second cell may be associated with the third cell in that the second cell 15 is a master cell and the third cell 16 is a slave cell.

Several methods may be used to determine/form the association between the master and slave cells, such as:
The second radio access node 12 may determine the association by receiving a configuration from an operation and maintenance node indicating association between the second cell 15 and the third cell 16.

Hence, determination is done by configuration by Operation and Maintenance (O&M) node, if the operator has full knowledge of the deployment location and coverage areas of each and every cell. Namely each cell is configured with information about whether a neighbour cell has, under its coverage or proximity, one or more small cells. This information can be used to influence the handover policy, e.g. if the neighbour is associated with any small cell then handover to that neighbour can be prioritized.
The second radio access node 12 may determine the association by receiving an indication from the third radio access node 17 controlling the third cell 16, which indication indicates that the second cell 15 is the master cell. E.g. Dynamic configuration via Self Organising Network (SON) operations like Automatic Neighbor Relations (ANR) where wireless device measurements and handover may be used to identify the association. For example, a small cell, such as the third cell 16, may realize that most of its wireless devices are being handed over or offloaded, e.g. in case the small cell is a WLAN one, to a particular macro cell, such as the second cell 15, and choose that particular macro cell as its master. This can then be communicated towards the macro cell. Namely, the small cell base station, such as the third radio access node 17, can use signaling via e.g. the X2 interface, to communicate that the macro cell and the small cell are associated from a traffic offloading point of view. Consequently, the macro base station, the second radio access node 13 may signal to other neighbour base stations, see action 702, that there are associations with small cells. The latter can influence the handover policy of neighbour base stations, e.g. neighbour base stations may prioritise the macro cell for handover of served wireless devices on the basis that the small cells associated with the neighbour macro cell may be used for offloading purposes.

Action 702. The second radio access node 13 may transmit an indication to the first radio access node 12, which indication indicates that the second cell 15 is associated with the third cell 16. This indication may be used to influence the handover policy, e.g. if the second cell 15 is associated with any small cells, such as the third cell 16, then handover to that second radio access node 13 may be prioritized.

Action 703. The second radio access node 13 may determine the HAI of the second radio access node 13, which HAI indicates on how much the second cell 15 and the third cell 16 are able to accommodate wireless devices. The HAI may be based on load in the second cell 15 and/or load in the third cell 16.

For example, an index value of 0 for a macro cell can mean the macro cell as well as the small cells under its coverage area are overloaded, while a value of 10 can mean the load is negligible and the macro and its slave cells can accommodate new wireless devices. The second radio access node 13 may calculate the HAI value by considering their own capacity and load as well as the capacities and loads of all their slave cells, e.g. using weighted averaging. A small cell, on the other hand, might not broadcast any HAI or if it does the index value corresponds to the affinity of that small cell only.

Action 704. The second radio access node 13 may broadcast an indication of the HAI within the second cell 15. Hence, in some embodiments, the second radio access node 13 broadcasts an index, herein referred to as HAI, the value of which determines on how much the second cell 15 is able to accommodate new wireless devices.

Action 705. The second radio access node 13 may transmit an indication of the HAI to the first radio access node 12. Hence, the HAI may be signaled to a neighbor macro cell such as the first radio access node 12. It should be noted that if the HAI is broadcasted it might not be needed be explicitly communicate the HAI to the neighboring cells. Another alternative is for the load information of the second cell 15 and the associated third cell 16 under its coverage to be communicated to the first radio access node 12. Then the first radio access node 12 receiving this information may calculate the HAI of its neighbors, such as the HAI for the second and/or third cell. The signaling may occur e.g. via X2 interface, for example as part of the LOAD INFORMATION procedures.

In some other embodiments, the macro cells, such as the second radio access node 13, reports neighbor-specific HAI values. For example, consider neighboring macro cells A, B and C, and that there are 10 small cells in B, and 9 of them are very close to the cell border of cell A while only 1 is close to the border of cell C. Thus that means that the affinity to receive wireless devices from cell A might be much higher than from cell C, so cell B, such as the second radio access node 13, may broadcast different HAI values along with to which neighbor cell they refer to, e.g., {HAI1, A}; {HAI2, B}; etc. In this way wireless devices coming from cell A can use different HAI values than the wireless devices coming from cell B. Another possibility is to have a scaling factor communicated between neighbor macros, i.e. sent to the first radio access node 12, and the cells configure their wireless devices report triggering parameters with this scaling factor. For the example above, cell B can tell A to scale up the affinity by a certain value, and cell C to scale down the affinity by a certain value, and cell A can configure the event Ay so that HAI values are lowered, and cell C can configure the event Ay so that HAI values are increased.

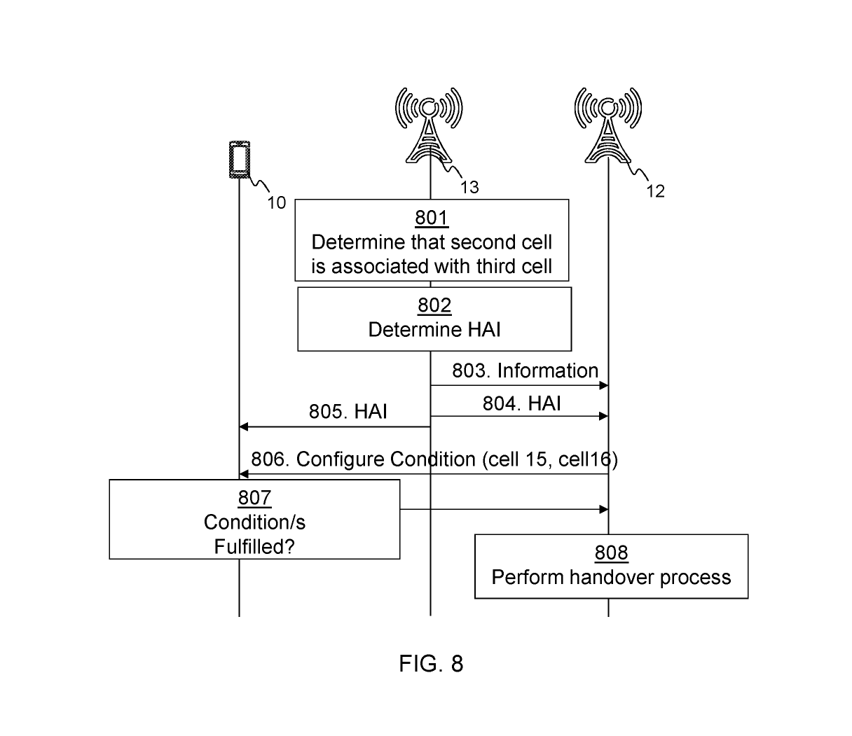

FIG. 8 is a schematic overview depicting an example of a method in the radio communications network according to embodiments herein.

Action 801. The second radio access node 13 determines the association between the second cell 15 and the third cell 16 e.g. configured from the O&M node.

Action 802. The second radio access node 13 determines the HAI of the second radio access node 13 taking into account said association.

Action 803. The second radio access node 13 transmits information indicating the association of the second and third cell to the first radio access node 12.

Action 804. The second radio access node 13 transmits the HAI to the first radio access node 12.

Action 805. The second radio access node 13 may further broadcast the HAI within the second cell 15.

Action 806. The first radio access node 12 then configures the wireless device with one or more conditions taking into account the received HAI e.g. the one or more conditions relate to the second cell 15 and the third cell 16.

Action 807. The wireless device 10 then determines whether the condition/s are fulfilled and when fulfilled reports the signal measurement to the first radio access node 12, based on e.g. signal strengths and/or received HAI.

Action 808. The first radio access node 12 receives the signal measurements and performs a handover process based on the received signal measurements talking into account that the second cell 15 is associated with the third cell 16, e.g. being a master and a slave cell.

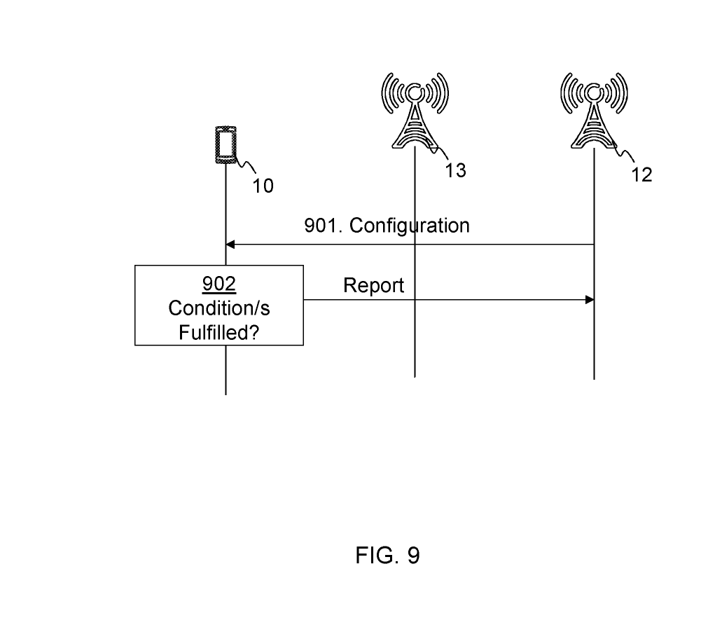

FIG. 9 is a schematic overview depicting some embodiments regarding the configuration herein where the first radio access node 12, e.g. source eNB, configures the wireless device 10 within the radio communications network 1. The radio communications network 1 further comprises the second cell 15 controlled by the second radio access node, e.g. a target eNB (eNB2), and a different, the third, cell associated with the second cell 15. The third cell 16 being served by a different radio access node, such as the third radio access node 17, e.g. a WLAN modem or a node of the same technology as the second radio access node 13, of e.g. smaller transmission power, is associated with the second cell 15, e.g. the second radio access node 13 being a master node and the third radio access node 17 being a slave node.

Action 901. The first radio access node 12 may configure the wireless device by sending to the wireless device 10 the condition/s for triggering reporting measurements to the first radio access node 12. The condition/s comprise e.g. threshold values for the second cell 15 controlled by the second radio access node 13, and for the third cell 16, or a threshold value taking both data regarding the second and the third cell into consideration.

Action 902. The wireless device 10 checks if the condition/s is fulfilled and sends a measurement report when the condition/s is fulfilled.

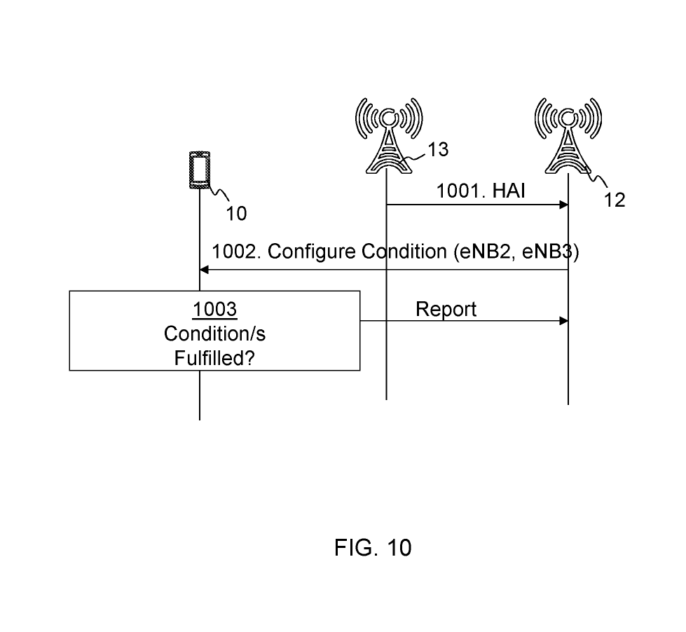

FIG. 10 is a schematic overview depicting embodiments herein where the first radio access node 12 configures the wireless device 10 within the radio communications network 1.

Action 1001. The second radio access node 13 transmits information, e.g. composite HAI value that considers load and other conditions in the second and the third cell, to the first radio access node 12.

Action 1002. The first radio access node 12 configures the wireless device 10 by sending one or more conditions, which may be different for different neighbour cells, depending on the information received in a message in action 1001 from each neighbour cell. The condition/s may comprise, e.g. neighbour cell specific threshold values for triggering measurement reports.

Action 1003. The wireless device 10 checks if the condition/s is fulfilled and sends a measurement report when the condition/s is fulfilled.

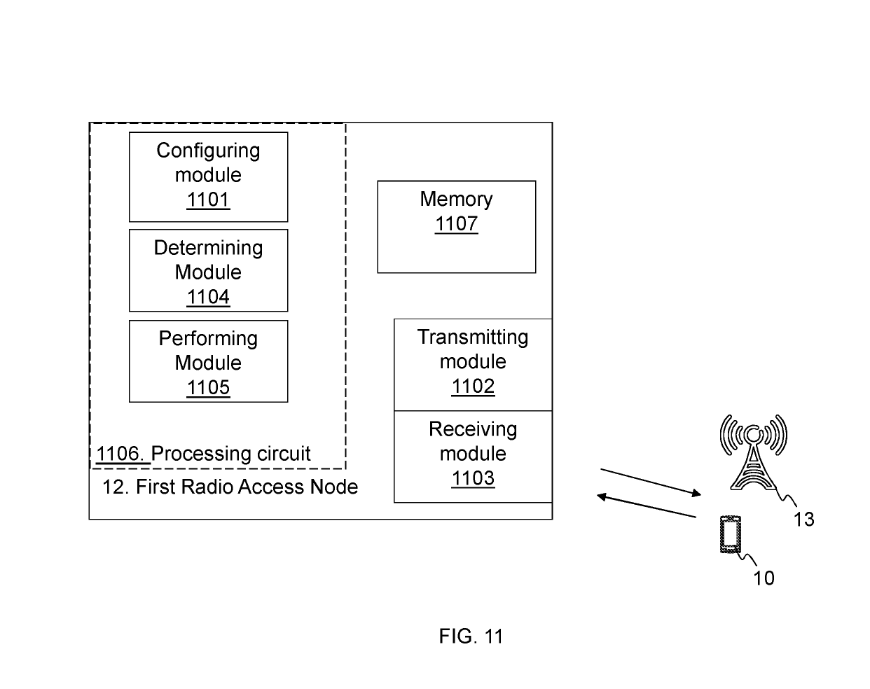

In order to perform the method herein a first radio access node is provided. FIG. 11 discloses a block diagram depicting the first radio access node 12 for handling mobility of the wireless device 10 in the radio communications network 1. The radio communications network 1 comprises the first radio access node 12 controlling the first cell 11 and the second radio access node 13 controlling the second cell 15.

The radio access node 12 may comprise a configuring circuit or module 1101. The first radio access node 12 and/or the configuring module 1101 may be configured to configure the wireless device 10 with one or more conditions to trigger a measurement report of received signals. The one or more conditions being at least partly related to the second cell 15 controlled by the second radio access node 13, and also to a third cell 16 associated with the second cell 15. The second cell 15 may be associated with the third cell 16 in that the second cell 15 is a master cell and the third cell 16 is a slave cell. The one or more conditions may indicate one or more rules for triggering reporting of received signal strengths, the one or more rules indicate a threshold value for each cell, wherein the threshold values may be based on the HAI of the second cell 15 and the third cell 16, respectively.

Furthermore, the first radio access node 12 may comprise a transmitting module or circuit 1102. The first radio access node 12 and/or the transmitting module may be configured to send configuration data to the wireless device 10 indicating the one or more conditions by indicating one or more rules for triggering reporting of received signal strengths. The one or more rules may comprise threshold values of the second cell 15 and the third cell 16, respectively. The threshold values may be absolute values or values relative values of the first radio access node 12 or other radio access nodes. The one or more rules may be related to the HAI of the second radio access node 13, which HAI indicates on how much the second cell 15 and third cell 16 are able to accommodate wireless devices.

The first radio access node 12 may further comprise a receiving module or circuit 1103. The first radio access node 12 and/or the receiving module 1103 may be configured to receive an indication of the HAI of the second radio access node 13 from the second radio access node 13. Furthermore, the first radio access node 12 and/or the receiving module 1103 may, additionally or alternatively, be configured to receive a measurement report of the second cell 15 and/or third cell 16 from the wireless device 10 indicating fulfilled one or more conditions.

The first radio access node 12 may further comprise a determining module or circuit 1104. The first radio access node 12 and/or the determining module 1104 may be configured to determine the HAI of the second radio access node 13 based on load in the second radio access node 13. In addition, the first radio access node 12 and/or the determining module 1104 may, additionally or alternatively, further be configured to determine that the second cell 15 is associated with a third cell 16 based on a received indication from the second radio access node 13 indicating that the second cell 15 is associated with the third cell 16. The first radio access node 12 and/or the determining module 1104 may, additionally or alternatively, be configured to determine whether to handover the wireless device 10 to the second radio access node 12 based on the received measurement report and/or capability of the wireless device 10.

The first radio access node 12 may further comprise a performing module or circuit 1105. The first radio access node 12 and/or the performing module 1105 may be configured to perform a handover process of the wireless device 10 from the first cell 11 to the second cell 15 taking into account that the second cell 15 is associated with the third cell 16.

The embodiments and modules herein for handling mobility of the wireless device may be implemented through a processing circuit 1106 comprising one or more processors in the first radio access node 12 depicted in FIG. 11, together with e.g. computer program code for performing the functions and/or method actions of the embodiments herein. The program code mentioned above may also be provided as a computer program product, for instance in the form of a data carrier carrying computer program code for performing embodiments herein when being loaded into the radio access node. One such carrier may be in the form of a CD ROM disc. It is however feasible with other data carriers such as a memory stick. The computer program code may furthermore be provided as pure program code on a server and downloaded to the radio access node.

The first radio access node 12 may further comprise a memory 1107 to be used to store threshold values, association data, rules, master-slave relations, cell data, application to perform the method and/or similar.

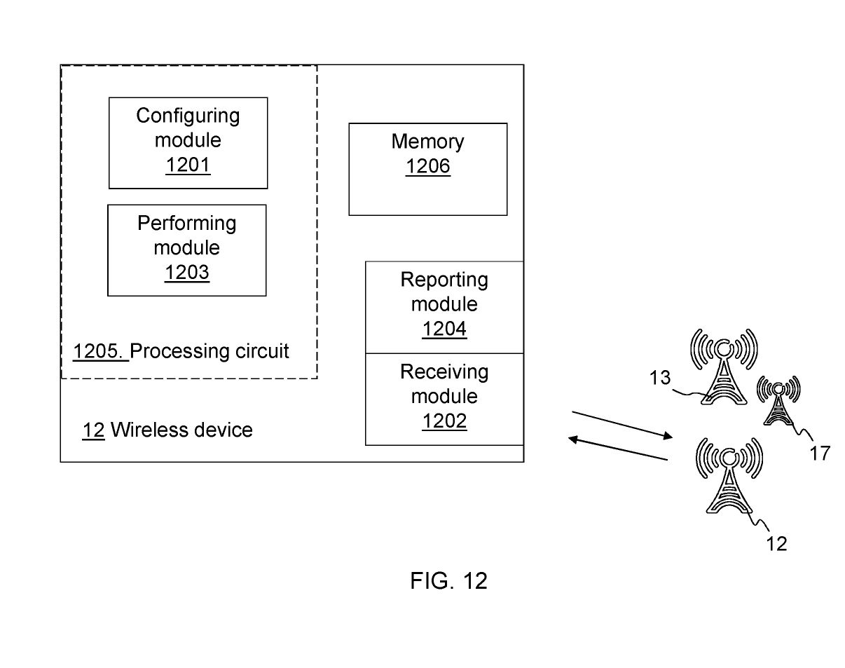

In order to perform methods herein a wireless device is provided. FIG. 12 shows a block diagram depicting the wireless device 10 for handling signal measurements to the first radio access node 12 in the radio communications network 1. The radio communications network 1 comprises the first radio access node 12 controlling the first cell 11 and the second radio access node 13 controlling the second cell 15.

The wireless device 10 may comprise a configuring module or circuit 1201. The wireless device 10 and/or the configuring module 1201 may be configured to configure settings, from the first radio access node 12, to trigger a reporting of a signal measurement when one or more conditions are fulfilled. The one or more conditions are at least partly related to the second cell 15 controlled by the second radio access node 13, and also to the third cell 16 associated with the second cell 15. The second cell 15 may be associated with the third cell 16 in that the second cell 15 is a master cell and the third cell 16 is a slave cell.

The wireless device 10 may comprise a receiving module or circuit 1202. The wireless device 10 and/or the receiving module 1202 may be configured to receive configuration data from the first radio access node 13 indicating the one or more conditions by indicating one or more rules for triggering reporting of received signal strengths. The one or more rules may comprise threshold values of the second cell 15 and the third cell 16, respectively. The threshold values may be absolute values or values relative values of the first radio access node 12 or other radio access nodes. In addition or alternatively, the wireless device 10 and/or the receiving module 1202 may be configured to receive an indication from the third radio access point 17 controlling the third cell 16. The indication indicates that the second cell 15 is a master cell. Then the one or more conditions may be related the master cell and a slave cell, which is a kind of status of the cell. Additionally or alternatively, the wireless device 10 and/or the receiving module 1202 may be configured to receive a broadcasted indication of the HAI of the second radio access node 13. The HAI indicates on how much the second cell 15 and third cell 16 are able to accommodate wireless devices. Then the one or more conditions may be related to the HAI. The wireless device 10 may further obtain data indicating that the third cell is associated with the second cell, e.g. being a slave cell to the second cell.

The wireless device 10 may comprise a performing module or circuit 1203. The wireless device 10 and/or the performing module 1203 may be configured to perform a signal measurement on the second cell 15 and/or the third cell 16.

The wireless device 10 may comprise a reporting module or transmitting circuit 1204. The wireless device 10 and/or the reporting module 1204 may be configured to, when the one or more conditions are fulfilled to, report the signal measurement to the first radio access node 12.

The embodiments herein for handling signal measurements may be implemented through a processing circuit 1205 comprising one or more processors in the wireless device 10 depicted in FIG. 12, together with e.g. computer program code for performing the functions and/or method actions of the embodiments herein. The program code mentioned above may also be provided as a computer program product, for instance in the form of a data carrier carrying computer program code for performing embodiments herein when being loaded into the wireless device. One such carrier may be in the form of a CD ROM disc. It is however feasible with other data carriers such as a memory stick. The computer program code may furthermore be provided as pure program code on a server and downloaded to the wireless device.

The wireless device may further comprise a memory 1206 to be used to store threshold values, association data, rules, master/slave relations, cell data, application to perform the method and/or similar.

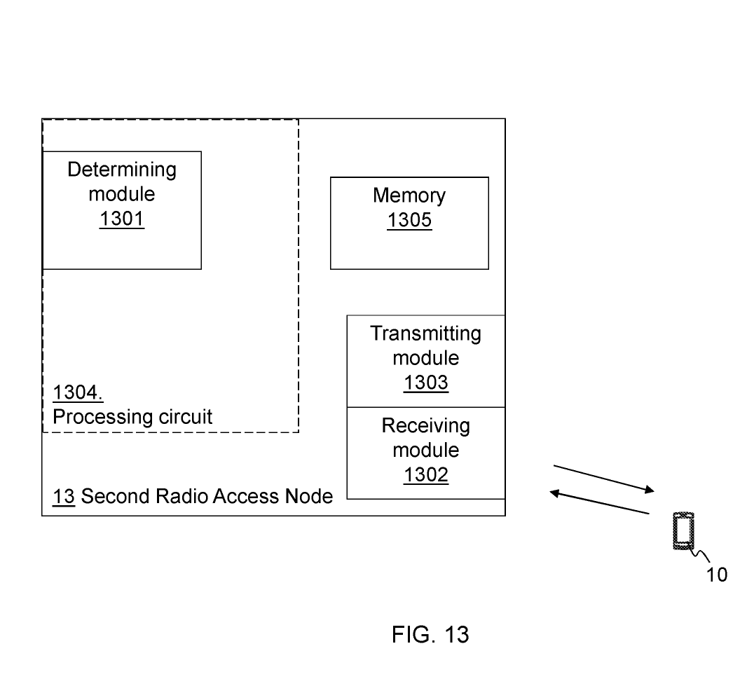

In order to perform method herein a second radio access node is provided. FIG. 13 shows a block diagram depicting the second radio access node 13 for supporting mobility of the wireless device 10 in the radio communications network 1. The radio communications network 1 comprises the second radio access node 13 controlling the second cell 15 and the first radio access node 12 controlling the first cell 11.

The second radio access node 13 may comprise a determining module 1301. The second radio access node 13 and/or the determining module 1301 may be configured to determine that the second cell 15 is associated with the third cell 16. The second cell 15 may be associated with the third cell 16 in that the second cell 15 is a master cell and the third cell 16 is a slave cell. Additionally, the second radio access node 13 and/or the determining module 1301 may be configured to determine the HAI of the second radio access node 13, which HAI indicates on how much the second cell 15 and third cell 16 are able to accommodate wireless devices. The HAI may be based on load in the second cell 15 and/or load in the third cell 16.

The second radio access node 13 may comprise a receiving module 1302. The second radio access node 13 and/or the receiving module 1302 may be configured to receive an indication from the third radio access node 17 controlling the third cell 16, which indication indicates that the second cell 15 is the master cell. Additionally, or alternatively, the second radio access node 13 and/or the receiving module 1302 may be configured to receive a configuration from an operation and maintenance node indicating association between the second cell 15 and the third cell 16.

The second radio access node 13 may comprise a transmitting module 1303. The second radio access node 13 and/or the transmitting module 1303 may be configured to transmit an indication to the first radio access node 12, which indication indicates that the second cell 15 is associated with the third cell 16. Additionally or alternatively, the second radio access node 13 and/or the transmitting module 1303 may be configured to broadcast an indication of the HAI within the second cell 15. Additionally or alternatively, the second radio access node 13 and/or the transmitting module 1303 may be configured to transmit an indication of the HAI to the first radio access node 12.

The embodiments herein for handling/managing handover procedure may be implemented through a processing circuit 1304 comprising one or more processors in the second radio access node 13 depicted in FIG. 13, together with e.g. computer program code for performing the functions and/or method actions of the embodiments herein. The program code mentioned above may also be provided as a computer program product, for instance in the form of a data carrier carrying computer program code for performing embodiments herein when being loaded into the radio access node. One such carrier may be in the form of a CD ROM disc. It is however feasible with other data carriers such as a memory stick. The computer program code may furthermore be provided as pure program code on a server and downloaded to the radio access node.

The second radio access node 13 may further comprise a memory 1305 to be used to store threshold values, association data, rules, master slave relations, cell data such as HAI, load, application to perform the method and/or similar.

As will be readily understood by those familiar with communications design, that functions from circuits or modules may be implemented using digital logic and/or one or more microcontrollers, microprocessors, or other digital hardware. In some embodiments, several or all of the various functions or modules may be implemented together, such as in a single application-specific integrated circuit (ASIC), or in two or more separate devices with appropriate hardware and/or software interfaces between them. Several of the functions/modules may be implemented on a processor shared with other functional components of a wireless device or network node, for example.

Alternatively, several of the functional elements of the processing circuits discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance tradeoffs inherent in these design choices.

It will be appreciated that the foregoing description and the accompanying drawings represent non-limiting examples of the methods and apparatus taught herein. As such, the inventive apparatus and techniques taught herein are not limited by the foregoing description and accompanying drawings. Instead, the embodiments herein are limited only by the following claims and their legal equivalents.

### ABBREVIATIONS

### 3GPP 3rd Generation Partnership Project

### CN Core Network

### UTRAN Universal Terrestrial Radio Access Network

### GERAN GSM EDGE Radio Access Network

### HO Hand Over

### MRO Mobility Robustness Optimization

IRAT inter-RAT

### LTE Long Term Evolution

### RAT Radio Access Technology

eNB evolved Node B

### RNC Radio Network Controller

UE Wireless device

### RSRP Reference Signal Received Power

### RSRQ Reference Signal Received Quality

1.-30. (canceled)

31. A first radio access node for handling mobility of a wireless device in a radio communications network, which radio communications network comprises the first radio access node controlling a first cell and a second radio access node controlling a second cell the first radio access node being configured to:
configure the wireless device with one or more conditions to trigger a measurement report of received signals, which one or more conditions are at least partly related to the second cell controlled by the second radio access node, and also to a third cell associated with the second cell.

32. A first radio access node according to claim 31, wherein the second cell is associated with the third cell in that the second cell is a master cell and the third cell is a slave cell.

33. A first radio access node according to claim 31, wherein the first radio access node is further configured to send configuration data to the wireless device indicating the one or more conditions by indicating one or more rules for triggering reporting of received signal strengths.

34. A first radio access node according to claim 33, wherein the one or more rules comprise threshold values of the second cell and the third cell, respectively.

35. A first radio access node according to claim 34, wherein the threshold values are absolute values or values relative values of the first radio access node or other radio access nodes.

36. A first radio access node according to claim 31, wherein the one or more rules are related to a handover affiliated index, HAI, of the second radio access node, which HAI indicates on how much the second cell and third cell are able to accommodate wireless devices.

37. A first radio access node according to claim 36, further being configured to receive an indication of the HAI of the second radio access node from the second radio access node.

38. A first radio access node according to claim 36, further being configured to determine the HAI of the second radio access node based on load in the second radio access node.

39. A first radio access node according to claim 36, wherein the one or more conditions indicate one or more rules for triggering reporting of received signal strengths, the one or more rules indicate a threshold value for each cell, wherein the threshold values are based on the HAI of the second cell and the third cell, respectively.

40. A first radio access node according to claim 31, further being configured to:
determine that the second cell is associated with a third cell based on a received indication from the second radio access node indicating that the second cell is associated with the third cell.

41. A first radio access node according to claim 31, further being configured to:
perform a handover process of the wireless device from the first cell to the second cell taking into account that the second cell is associated with the third cell.

42. A first radio access node according to claim 41, further being configured to:
receive a measurement report of the second cell and/or third cell from the wireless device indicating fulfilled one or more conditions, and
to determine whether to handover the wireless device to the second radio access node based on the received measurement report and/or capability of the wireless device.

43. A wireless device for handling signal measurements to a first radio access node in a radio communications network, which radio communications network comprises the first radio access node controlling a first cell and a second radio access node controlling a second cell; being configured to:
configure settings, from the first radio access node, to trigger a reporting of a signal measurement when one or more conditions are fulfilled, wherein the one or more conditions are at least partly related to the second cell controlled by the second radio access node, and also to a third cell associated with the second cell.

44. A wireless device according to claim 43, wherein the second cell is associated with the third cell in that the second cell is a master cell and the third cell is a slave cell.

45. A wireless device according to claim 43, further being configured to:
receive configuration data from the first radio access node indicating the one or more conditions by indicating one or more rules for triggering reporting of received signal strengths.

46. A wireless device according to claim 45, wherein the one or more rules comprise threshold values of the second cell and the third cell, respectively.

47. A wireless device according to claim 46, wherein the threshold values are absolute values or values relative values of the first radio access node or other radio access nodes.

48. A wireless device according to claim 43, further being configured to:
receive an indication from a third radio access point controlling the third cell, which indication indicates that the second cell is a master cell and wherein the one or more conditions are related the master cell and a slave cell.

49. A wireless device according to claim 43, further being configured to:
receive a broadcasted indication of a handover affiliated index, HAI, of the second radio access node, which HAI indicates on how much the second cell and third cell are able to accommodate wireless devices, wherein the one or more conditions are related to the HAI.

50. A wireless device according to claim 43, further being configured to:
perform a signal measurement on the second cell and/or the third cell; and when the one or more conditions are fulfilled to
report the signal measurement to the first radio access node.

51. A second radio access node for supporting mobility of a wireless device in a radio communications network, which radio communications network comprises the second radio access node controlling a second cell and a first radio access node controlling a first cell; the second radio access node being configured to:
determine that the second cell is associated with a third cell.

52. A second radio access node according to claim 51, wherein the second cell is associated with the third cell in that the second cell is a master cell and the third cell is a slave cell.

53. A second radio access node according to claim 51, further being configured to:
receive an indication from a third radio access node controlling the third cell, which indication indicates that the second cell is the master cell.

54. A second radio access node according to claim 51, further being configured to:
receive a configuration from an operation and maintenance node indicating association between the second cell and the third cell.

55. A second radio access node according to claim 51, further being configured to:
transmit an indication to the first radio access node, which indication indicates that the second cell is associated with the third cell.

56. A second radio access node according to claim 51, further being configured to:
determine a handover affiliated index, HAI, of the second radio access node, which HAI indicates on how much the second cell and third cell are able to accommodate wireless devices.

57. A second radio access node according to claim 56, wherein the HAI is based on load in the second cell and/or load in the third cell.

58. A second radio access node according to claim 56, further being configured to:
broadcast an indication of the HAI within the second cell.

59. A second radio access node according to claim 56, further being configured to:
transmit an indication of the HAI to the first radio access node.
